(19) United States
(12) Patent Application Publication
(10) Pub. No.: US 2019/0232651 A1
(43) Pub. Date: Aug. 1, 2019

(54) INKJET RECORDING APPARATUS

(71) Applicant: Konica Minolta, Inc., Tokyo (JP)

(72) Inventors: Mitsuo KABURAGI, Tokyo (JP); Takahiro HARA, Tokyo (JP)

(21) Appl. No.: 16/260,628

(22) Filed: Jan. 29, 2019

(30) Foreign Application Priority Data
Jan. 31, 2018 (JP) 2018-014814

(51) Int. Cl. B41J 2/14

(52) U.S. Cl. CPC B41J 2/14; B41J 2002/012

(57) ABSTRACT

An inkjet recording apparatus includes a belt, an image forming unit, a transfer unit, a heating unit, and a hardware processor. The belt is laid across at least two rollers so as to move around the rollers. The image forming unit ejects an ink to an image forming region of the belt, thereby forming a primary image. The image forming region is arranged between the rollers. The transfer unit transfers the primary image formed in the image forming region by the image forming unit to a recording medium. The heating unit heats the image forming region. The hardware processor controls a temperature of the image forming region by causing the heating unit to heat the image forming region.

### CROSS REFERENCE TO RELATED APPLICATIONS

The present invention claims priority under 35 U.S.C. § 119 to Japanese Application No. 2018-014814 filed Jan. 31, 2018, the entire content of which is incorporated herein by reference.

### BACKGROUND

### 1. Technological Field

The present invention relates to an inkjet recording apparatus.

### 2. Description of the Related Art

There are known inkjet recording apparatuses each of which ejects, from nozzles formed in recording heads, ink supplied to the recording heads, thereby forming a primary image on an intermediate transfer belt, and transferring the primary image on the intermediate transfer belt to a recording medium, thereby forming an image on the recording medium. (Refer to, for example, JP 2008-200855 A.)

Among these inject recording apparatuses, there is known an inkjet recording apparatus having a function of heating an intermediate transfer belt to a predetermined temperature. For example, there is known an inkjet recording apparatus configured such that an intermediate transfer belt is laid across two rollers in a tensioned state; between the two rollers, head units for respective colors are arranged side by side along a moving direction of the intermediate transfer belt; and of the two rollers, the roller on the upstream side has a built-in heating device.

In thus-configured apparatus, however, distances from the heating device to the head units are long. Hence, there are risks that temperature of the intermediate transfer belt decreases during image forming even if the intermediate transfer belt is heated to a predetermined temperature in advance, and accordingly ink viscosity changes, and ink droplets become hard without spreading, which affects image quality.

In addition, the distances from the heating device to the head units for the respective colors are different from one another. Hence, there are risks that ink viscosities of the respective colors become different from one another, and degrees of spread of ink droplets of the respective colors become various, which affects image quality.

### SUMMARY

The present invention has been conceived in view of the above problems, and objects of the present invention include providing an inkjet recording apparatus which can keep temperature of its intermediate transfer belt at a proper temperature, and achieve excellent image quality.

To achieve at least one of the abovementioned objects, according to an aspect of the present invention, there is provided an inkjet recording apparatus including: a belt which is laid across at least two rollers so as to move around the rollers; an image forming unit which ejects an ink to an image forming region of the belt, the image forming region being arranged between the rollers, thereby forming a primary image; a transfer unit which transfers the primary image formed in the image forming region by the image forming unit to a recording medium; a first heating unit which heats the image forming region; and a hardware processor which controls a temperature of the image forming region by causing the first heating unit to heat the image forming region.

### BRIEF DESCRIPTION OF THE DRAWINGS

The advantages and features provided by one or more embodiments of the present invention will become more fully understood from the detailed description given hereinbelow and the appended drawings which are given by way of illustration only, and thus are not intended as a definition of the limits of the present invention, wherein:

FIG. 1 shows schematic configuration of an inkjet recording apparatus of a first embodiment;

FIG. 2 is an enlarged view of a region R1 in FIG. 1;

FIG. 3 is a block diagram schematically showing configuration of a control system of the inkjet recording apparatus;

FIG. 4 is a flowchart of a temperature control process;

FIG. 5 shows schematic configuration of an inkjet recording apparatus of a second embodiment;

FIG. 6 is an enlarged view of a region R2 in FIG. 5; and

FIG. 7 is a diagram to explain an installation position of a heating unit (second heating member).

### DETAILED DESCRIPTION OF EMBODIMENTS

Hereinafter, one or more embodiments of the present invention will be described with reference to the drawings. However, the scope of the present invention is not limited to the disclosed embodiments.

### First Embodiment

Hereinafter, a first embodiment of the present invention will be described with reference to the drawings. However, the scope of the present invention is not limited to the embodiment(s) below or illustrated examples.

### [Configuration of Inkjet Recording Apparatus]

First, configuration of an inkjet recording apparatus 1 of this embodiment will be described.

The inkjet recording apparatus 1 is an inkjet recording apparatus employing a transfer recording system of forming a primary image on an intermediate transfer belt 11, and then transferring the primary image to a recording medium P.

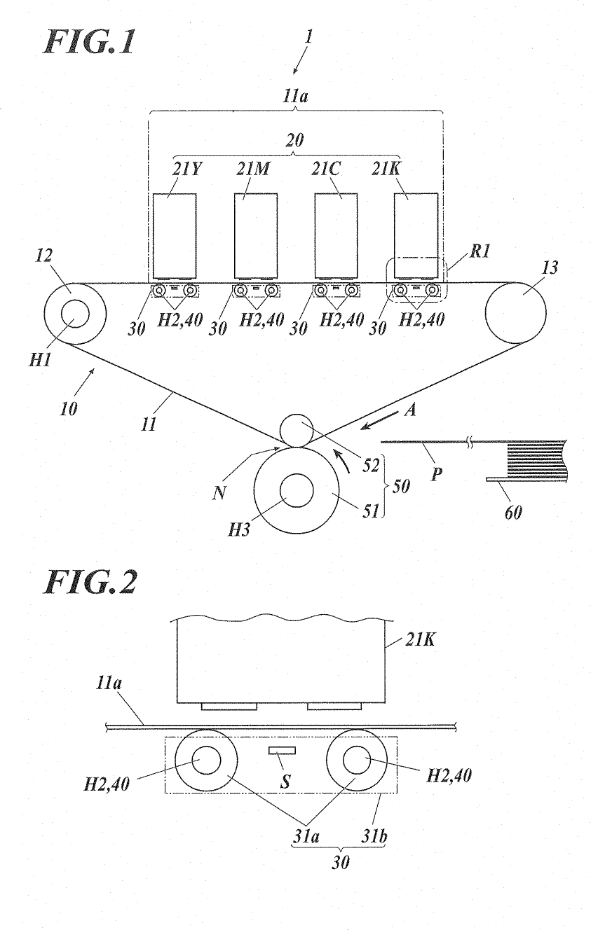

FIG. 1 shows schematic configuration of the inkjet recording apparatus 1.

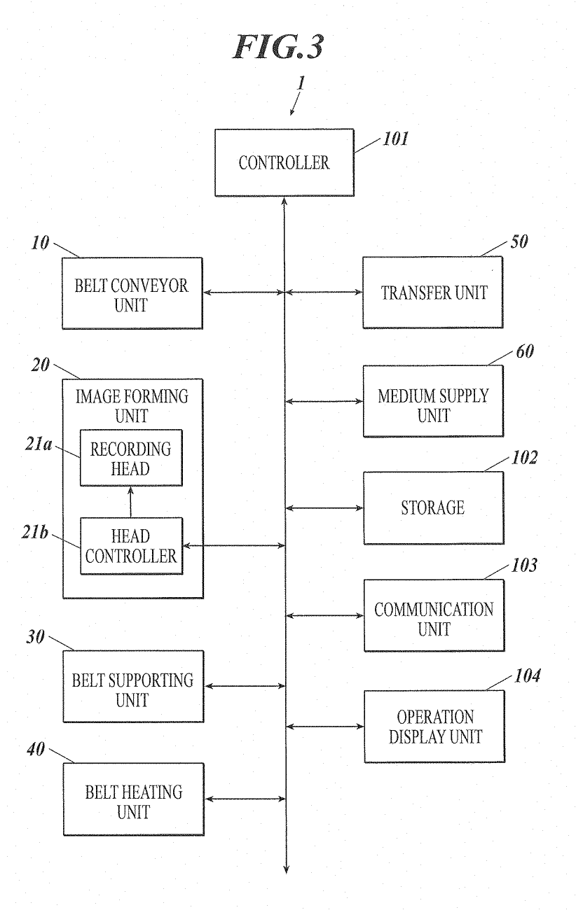

As shown in FIG. 1, the inkjet recording apparatus 1 includes a belt conveyor unit 10, an image forming unit 20, a belt supporting unit (supporting unit) 30, a belt heating unit (first heating unit) 40, a transfer unit 50, a medium supply unit 60, and a controller 101 (shown in FIG. 3).

The belt conveyor unit 10 includes the intermediate transfer belt 11, a drive roller 12 and a driven roller 13.

The intermediate transfer belt 11 is, for example, an endless belt wounded around the drive roller 12, the driven roller 13, and a pressure roller 52 of the transfer unit 50, and moves (circles) around the rollers 12, 13 and 52 in a direction indicated by an arrow A in FIG. 1 at a constant speed according to rotation of the drive roller 12.

The moving speed of the intermediate transfer belt 11 can be changed as needed according to a period of ink ejection of the image forming unit 20 and resolution of an image(s) to be formed. The move of the intermediate transfer belt 11 may be intermittent. For example, the intermediate transfer belt 11 stops while the image forming unit 20 is ejecting ink. Further, reducing the moving speed of the intermediate transfer belt 11 prevents generation of glossiness difference and increases image quality, the glossiness difference being generated by image's unevenness generated by a surface layer of dropped ink cured in an insufficient heat supply time for the piled-up ink (many ink droplets), thickness of a recording medium P, or the like.

The outer surface (image forming surface) of the intermediate transfer belt 11 has image forming regions 11a which face the image forming unit 20 and where primary images are formed. The image forming regions 11a are formed of resin, metal, rubber or the like to be impermeable to resin droplets or ink droplets.

More specifically, the material preferably used for the image forming surface of the intermediate transfer belt 11 may be publicly known material. Examples thereof include polyimide resin, silicon resin, polyurethane resin, polyether resin, polystyrene resin, polyolefin resin, polybutadiene resin, polyamide resin, polyvinyl chloride resin, polyethylene resin, and fluororesin.

The intermediate transfer belt 11 may have a multilayer structure having, on the back of the image forming surface, a support layer having a predetermined level of stiffness.

Of the intermediate transfer belt 11, at least the image forming regions 11a are horizontal planes (flat planes) having a predetermined level of flatness.

The drive roller 12 rotates on a pivot by being driven by a not-shown motor. The drive roller 12 is provided with an encoder (rotary encoder) on the pivot, so that the circling distance of the intermediate transfer belt 11 is measurable.

The drive roller 12 has a built-in first heating member H1, such as a halogen heater. Hence, the intermediate transfer belt 11 is heated while it is moving around the rollers 12, 13 and 52, and the drive roller 12 and the first heating member H1 function as a preheating unit which heats the intermediate transfer belt 11 to a preset initial temperature before the image forming unit 12 forms a primary image(s) thereon.

The driven roller 13 is arranged a predetermined distance away from the drive roller 12, and rotates on a pivot which is parallel to the pivot of the drive roller 12 according to the circling of the intermediate transfer belt 11.

The image forming unit 20 is arranged between the drive roller 12 and the driven roller 13 on the outer surface side of the intermediate transfer belt 11.

The image forming unit 20 ejects ink from nozzles to the image forming surface of the intermediate transfer belt 11 on the basis of image data, thereby forming a primary image(s) in the image forming region(s) 11a.

The image forming unit 20 includes four head units 21Y, 21M, 21C and 21K for inks of four colors of yellow (Y), magenta (M), cyan (C) and black (K). These four head units 21Y, 21M, 21C and 21K are arranged in this order from the upstream side in the moving direction of the intermediate transfer belt 11 at predetermined intervals.

The number of the head units and the colors of the inks ejected from the head units are not limited to those described above.

Each head unit 21 includes: a plurality of recording heads 21a (shown in FIG. 3) in each of which a plurality of recording elements are arranged in the width direction of the intermediate transfer belt 11 (hereinafter simply “width direction”) intersecting at right angles to the moving direction of the intermediate transfer belt 11; and a head controller 21b (shown in FIG. 3) which controls an ink ejection operation of the recording heads 21a.

Each recording head 21a has an ink ejection surface where opening parts of the nozzles are provided, and the ink ejection surface is arranged so as to face the image forming surface of the intermediate transfer belt 11.

The recording elements included in the recording head 21a each include: a pressure chamber where ink is stored; a piezoelectric element arranged on the wall surface of the pressure chamber; and a nozzle from which the ink is ejected. When drive signals are applied to the piezoelectric elements from a drive circuit in the recording head 21a, in response to the drive signals, the pressure chambers deform and the pressures in the pressure chambers change, and the ink is ejected from the nozzles which communicate with the pressure chambers (ink ejection operation).

An arrangement range of the recording elements in each head unit 21 in the width direction covers a dimension of the image forming regions 11a of the intermediate transfer belt 11 in the width direction. When forming primary images, the head units 21 are used with their positions fixed with respect to the intermediate transfer belt 11. That is, the inkjet recording apparatus 1 forms primary images by a single-pass system.

The inkjet recording apparatus 1 may form primary images by a scanning system, namely, with the recording heads 21a, which eject ink, performing scanning in the width direction along the image forming surface of the intermediate transfer belt 11.

Each head controller 21b outputs various control signals and image data to a head drive unit for the recording heads 21a at appropriate timings in accordance with control signals form the controller 101 and/or counts of a pulse signal(s) input from the encoder attached to the drive roller 12.

In accordance with the control signals and the image data input from the head controller 21b, the head drive unit for the recording heads 21a supplies the drive signals for deforming the piezoelectric elements to the recording elements of the recording heads 21a, thereby causing the recording elements to eject ink from the nozzles through the opening parts.

The belt supporting unit 30 is for keeping the distances from the ink ejection surfaces of the head units 21 to the image forming surface of the intermediate transfer belt 11 the same.

The belt supporting unit 30 is arranged between the drive roller 12 and the driven roller 13 on the inner surface (opposite to the image forming surface) side of the intermediate transfer belt 11. That is, the belt supporting unit 30 is arranged so as to face the image forming unit 20 via the intermediate transfer belt 11.

In this embodiment, the belt supporting unit 30 includes four pairs of rollers 31a, 31a which face the four head units 21Y, 21M, 21C and 21K on a pair-to-unit basis.

FIG. 2 is an enlarged view of a region R1 in FIG. 1.

As shown in FIG. 2, the rollers 31a, 31a of each pair are arranged a predetermined distance away from one another such that their upper parts contact the inner surface of the intermediate transfer belt 11. Each pair of the rollers 31a, 31a is surrounded and protected by a cover 31b.

Because these rollers 31a, 31a support the intermediate transfer belt 11, the distances from the ink ejection surfaces of the recording heads 21a of the four head units 21Y, 21M, 21C and 21K of the image forming unit 20 to the image forming surface of the intermediate transfer belt 11 are kept the same, and accordingly ink flying distances are the same, so that image quality can be excellent.

In this embodiment, two rollers 31a, 31a are arranged so as to face each head unit 21. However, the number of the rollers 31a facing each head unit 21 is not limited thereto.

The belt heating unit 40 is arranged near the image forming regions 11a of the intermediate transfer belt 11, and heats the image forming regions 11a.

In this embodiment, the belt heating unit 40 includes second heating members H2 built in the respective rollers 31a of the four pairs of the rollers 31a, 31a. Hence, the rollers 31a function as heating rollers.

The four pairs of the rollers 31a, 31a face the four head units 21Y, 21M, 21C and 21K on a pair-to-unit basis, and the rollers 31a function as the heating rollers, so that local temperature control of the image forming regions 11a for the four head units 21 is available.

The second heating members H2 are, for example, heating elements, such as halogen heaters, and individually controlled by the controller 101 so as to generate predetermined amounts of heat (heat amounts), and heat the image forming regions 11a of the intermediate transfer belt 11. The individual control of the second heating members H2 enables accurate temperature control of the image forming regions 11a of the intermediate transfer belt 11.

Between the rollers 31a, 31a of each pair, a temperature sensor (detector) S is arranged. Hence, temperatures in the vicinities of the respective image forming regions 11a for the four head units 21 are detectable. The temperature sensors S output detection results to the controller 101.

Referring back to FIG. 1, the transfer unit 50 transfers primary images on the intermediate transfer belt 11 to recording media P.

The transfer unit 50 includes a heating roller 51 and the pressure roller 52.

The heating roller 51 has a built-in third heating member H3, such as a halogen heater. The intermediate transfer belt 11 is laid across the pressure roller 52 in a tensioned state. The pressure roller 52 and the heating roller 51 form a nip part N in between.

Each recording medium P supplied from the medium supply unit 60 is nipped at the nip part N, and heated by the heating roller 51 to a predetermined temperature while being pressed by the pressure roller 52 with a predetermined pressure. In this manner, a primary image(s) formed on the intermediate transfer belt 11 is transferred to each recording medium P.

The pressure roller 52 supports the intermediate transfer belt 11 from the inner surface side thereof together with the drive roller 12 and the driven roller 13, and plays a role to absorb sags of the intermediate transfer belt 11.

The medium supply unit 60 includes a medium housing unit and a supply roller (both not shown), and supplies recording media P to the nip part N.

In the medium housing unit, recording media P are stacked and housed, and the top recording medium P of the recording media P housed in the medium housing unit is sent by the supply roller to the nip part N of the transfer unit 50.

Configuration of the medium supply unit 60 is not particularly limited as long as the medium supply unit 60 can supply recording media P to the nip part N.

As the recording media P, various types of media are usable. Examples thereof include paper, plastic, metal, fabric, and rubber. Examples of the paper include plain paper, paperboard, coated paper, resin coated paper, and synthetic paper.

FIG. 3 is a block diagram schematically showing configuration of a control system of the inkjet recording apparatus 1.

As shown in FIG. 3, the controller 101 is connected to, for example, a storage 102, a communication unit 103, an operation display unit 104, the belt conveyor unit 10, the image forming unit 20, the belt supporting unit 30, the belt heating unit 40, the transfer unit 50, and the medium supply unit 60.

The controller 101 includes a central processing unit (CPU) and a random access memory (RAM). The CPU of the controller 101 reads a system program(s) and various process programs stored in the storage 102, loads the read programs to the RAM, and performs centralized control of operations of the components of the inkjet recording apparatus 1 in accordance with the loaded programs.

For example, in response to a command to execute an image forming job input from an external apparatus or the operation display unit 104, the controller 101 executes the job by causing the image forming unit 20 to form a primary image(s) on the intermediate transfer belt 11 on the basis of image data included in the job, and causing the transfer unit 50 to transfer the primary image(s) on the intermediate transfer belt 11 to a recording medium (media) P.

Further, the controller 101 performs a temperature control process (detailed below) which controls temperature of the intermediate transfer belt 11 to a predetermined temperature while the primary image(s) is/are being formed on the intermediate transfer belt 11.

The storage 102 is constituted of a nonvolatile semiconductor memory, a hard disk drive (HDD) and/or the like, and stores parameters, data and so forth needed by the components of the inkjet recording apparatus 1, in addition to the various programs, which the controller 101 executes.

The communication unit 103 sends/receives data, such as image forming jobs and image data, to/from external apparatuses (not shown), and is constituted of, for example, one or a combination of any of various serial interfaces and any of various parallel interfaces.

The operation display unit 104 includes: a display, such as a liquid crystal display or an organic EL display; and an input unit, such as operation keys or a touchscreen arranged on the screen of the display. The operation display unit 104 displays various types of information on the display, and converts input operations of a user(s) on the input unit into operation signals, and outputs the operation signals to the controller 101.

The user can set image forming conditions, such as a type and a basis weight of a recording media (media) P, and a quality, a density and a magnification of an image(s) to be formed, through the operation display unit 104. Further, the user can input commands to execute image forming jobs and instructions to instruct the image forming apparatus 1 to operate in various modes through the operation display unit 104.

### [Operation of Inkjet Recording Apparatus]

Next, operation of the inkjet recording apparatus 1 will be described.

The inkjet recording apparatus 1 performs the temperature control process which controls the temperature of the intermediate transfer belt 11 to a predetermined temperature while primary images are being formed on the intermediate transfer belt 11.

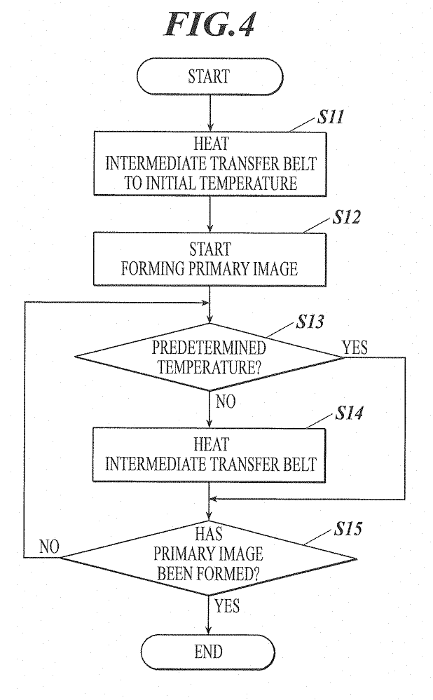

FIG. 4 shows a flowchart of the temperature control process.

First, the controller 101 causes the built-in first heating member H1 of the drive roller 12 to generate heat, and causes the intermediate transfer belt 11 to move around the rollers 12, 13 and 52 for a predetermined time, thereby heating the intermediate transfer belt 11 to a preset initial temperature (Step S11).

Next, the controller 101 causes the image forming unit 20 to start forming a primary image(s) on the image forming surface (image forming region(s) 11a) of the intermediate transfer belt 11 (Step S12).

Next, the controller 101 causes the temperature sensors S to detect temperatures of the image forming regions 11a of the intermediate transfer belt 11, and determines whether the temperatures of the image forming regions 11a of the intermediate transfer belt 11 each are (reach) a predetermined temperature (Step S13).

When determining that the temperatures of the image forming regions 11a each are (reach) the predetermined temperature (Step S13; YES), the controller 101 proceeds to Step S15 described below.

On the other hand, when determining that the temperature(s) of the image forming region(s) 11a is/are not the predetermined temperature (i.e., is/are lower than the predetermined temperature) (Step S13; NO), the controller 101 causes the second heating member(s) H2 to generate heat, thereby heating the intermediate transfer belt 11 (Step S14).

Preferably, the temperature(s) of (predetermined temperature for) the image forming regions 11a of the intermediate transfer belt 11 is set to suit the type or the basis weight of recording media P to be used. For example, if the recording media P are paper having a heavy basis weight (thick paper) or coated paper, the temperature of the intermediate transfer belt 11 is set high, and the heat amount of the first heating member H1 is set large.

Alternatively, the temperature(s) of (predetermined temperature for) the image forming regions 11a of the intermediate transfer belt 11 may be set to suit the quality or the density of images to be formed on the recording media P. That is, because ink temperature varies/fluctuates according to how ink is ejected, and, by extension, lands (quality or density of an image(s)), and already-landed-ink temperature affects ink to land next, the temperature(s) of the image forming regions 11a may be set to suit how ink is ejected.

Doing so prevents generation of glossiness difference and increases image quality, the glossiness difference being generated by image's unevenness generated by the surface layer of dropped ink cured in an insufficient heat supply time for the piled-up ink (many ink droplets), thickness of a recording medium P, or the like.

In Step S14, the controller 101 controls the second heating members H2 individually for the respective image forming regions 11a for the head units 21Y, 21M, 21C and 21K. Preferably, the heat amounts of the second heating members H2 are adjusted according to coverage rates or the like of the respective colors.

Next, the controller 101 determines whether the primary images have been formed (Step S15). When determining that the primary images have not been formed yet (Step S15; NO), the controller 101 returns to Step S13 and repeats Step S13 and the following step(s).

On the other hand, when determining that the primary images have been formed (Step S15; YES), the controller 101 ends the temperature control process.

This process controls the temperatures of the image forming regions 11a of the intermediate transfer belt 11 properly while primary images are being formed, and accordingly suppresses fluctuation in the ink temperature (viscosity) due to the temperature of the intermediate transfer belt 11 while primary images are being formed.

As described above, according to this embodiment, the inkjet recording apparatus 1 includes: the intermediate transfer belt 11 which is laid across the drive roller 12 and the driven roller 13 so as to move around the rollers 12 and 13 in a tensioned state; the image forming unit 20 which ejects ink(s) to the image forming region(s) 11a of the intermediate transfer belt 11, the image forming region(s) 11a being arranged between the drive roller 12 and the driven roller 13, thereby forming a primary image(s); the transfer unit 50 which transfers the primary image(s) formed in the image forming region(s) 11a by the image forming unit 20 to a recording medium (media) P; the belt heating unit 40 which heats the image forming region(s) 11a; and the controller 101 which controls the temperatures of the image forming region(s) 11a by causing the belt heating unit 40 to heat the image forming region(s) 11a.

This stabilizes the temperatures of the image forming regions 11a of the intermediate transfer belt 11, and can keep the temperatures of the inks ejected to the image forming regions 11a at a proper temperature, and accordingly can achieve excellent image quality.

Further, according to this embodiment, the image forming unit 20 includes the head units 21Y, 21M, 21C and 21K arranged side by side along the moving direction of the intermediate transfer belt 11, the belt heating unit 40 includes the second heating members H2 which heat the image forming regions 11a for the respective head units 21Y, 21M, 21C and 21K, and the controller 101 controls the heat amounts of the second heating members H2 individually.

This can keep the temperatures of the respective color inks at a proper temperature, and accordingly can form higher-quality images.

Further, according to this embodiment, the inkjet recording apparatus 1 further includes the temperature sensors S which detect the temperatures of the image forming regions 11a, wherein the controller 101 controls the heat amounts of the second heating members H2 based on the detection results by the temperature sensors S.

This enables more proper temperature control of the image forming regions 11a because the heat amounts of the second heating members H2 are controlled on the basis of the actual measurement results by the temperature sensors S.

Further, according to this embodiment, the inkjet recording apparatus 1 further includes the belt supporting unit 30 which supports the intermediate transfer belt 11 by the upper part of the belt supporting unit 30 contacting the back of the image forming regions 11a of the intermediate transfer belt 11, wherein the belt supporting unit 30 is provided with the belt heating unit 40.

This can keep the ink temperatures at a proper temperature in the state in which the ink flying distances are kept the same, and accordingly can form higher-quality images.

Further, according to this embodiment, the belt supporting unit 30 includes the rollers 31a, 31a which support the intermediate transfer belt 11 by the upper parts of the rollers 31a, 31a contacting the back of the image forming regions 11a of the intermediate transfer belt 11, and the second heating members H2 of the belt heating unit 40 are built in the rollers 31a, 31a.

This enables local temperature control of each image forming region 11a, and accordingly can form higher-quality images, because each image forming region 11a of the intermediate transfer belt 11 is supported by two rollers 31a, 31a.

Further, according to this embodiment, the controller 101 controls the temperatures of the image forming regions 11a according to the type or the basis weight of the recording medium (media) P.

This can form primary images on the intermediate transfer belt 11 suitable for recording media P.

Further, according to this embodiment, the controller 101 controls the temperatures of the image forming regions 11a according to the quality or the density of an image(s) to be formed on the recording medium (media) P.

This can form proper primary images on the intermediate transfer belt 11.

Further, according to this embodiment, the drive roller 12 and the first heating member H1 arranged on the upstream side of the belt heating unit 40 in the moving direction of the intermediate transfer belt 11 heats the intermediate transfer belt 11 before the image forming unit 20 forms the primary image to a preset initial temperature.

Thus, the image forming apparatus 1 is configured such that the drive roller 12 with the first heating member H1 heats the intermediate transfer belt 11 before a primary image(s) is formed thereon to the initial temperature, and if the temperature becomes lower than a predetermined temperature while the primary image(s) is/are being formed, the belt heating unit 40 heats the intermediate transfer belt 11.

### Second Embodiment

Next, a second embodiment of the present invention will be described.

The same/similar components as/to those in the first embodiment are given the same reference signs, and their descriptions are not repeated here.

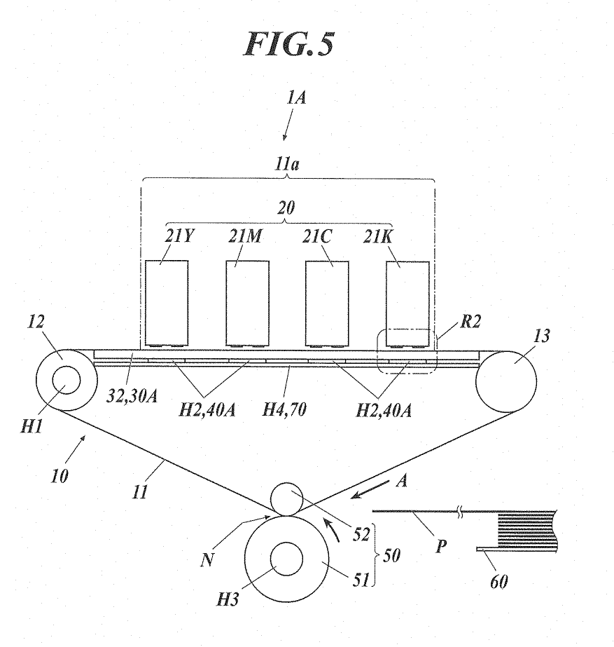

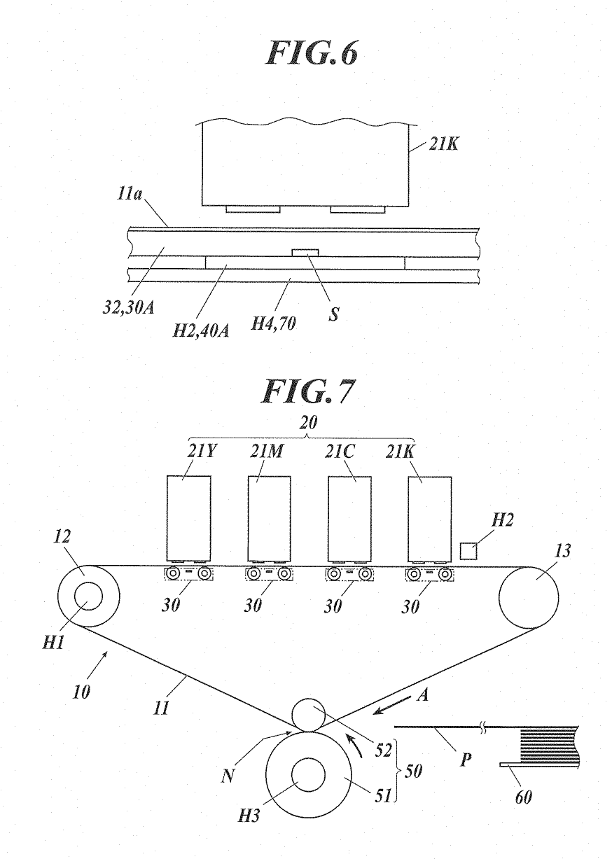

FIG. 5 shows schematic configuration of an inkjet recording apparatus 1A of the second embodiment. FIG. 6 is an enlarged view of a region R2 in FIG. 5.

The inkjet recording apparatus 1A includes the belt conveyor unit 10, the image forming unit 20, a belt supporting unit 30A, a belt heating unit 40A, the transfer unit 50, the medium supply unit 60, and the controller 101.

The belt supporting unit 30A is arranged between the drive roller 12 and the driven roller 13 on the inner surface side of the intermediate transfer belt 11.

In this embodiment, the belt supporting unit 30A includes a support plate 32 arranged such that its upper surface contacts the inner surface of the intermediate transfer belt 11. The support plate 32 is a plate formed of a material having a high thermal conductivity, such as metal, and detachable from the intermediate transfer belt 11.

The support plate 32 has a length in the moving direction of the intermediate transfer belt 11 to face all of the four head units 21.

Because the support plate 32 supports the intermediate transfer belt 11, the distances from the ink ejection surfaces of the four head units 21 to the image forming surface of the intermediate transfer belt 11 are kept the same. Further, because the support plate 32 supports the intermediate transfer belt 11, the ink flying distances are kept more exactly the same.

The belt heating unit 40A is arranged so as to contact the lower surface of the support plate 32, and includes four second heating members H2 arranged so as to face the four head units 21 of the image forming unit 20 one-to-one.

The second heating members H2 are, for example, heating elements, such as halogen heaters, and, as with the first embodiment, individually controlled by the controller 101 so as to generate predetermined heat amounts of heat (heat amounts), and heat the image forming regions 11a of the intermediate transfer belt 11. The second heating members H2 are detachable from the support plate 32.

Between the support plate 32 and the second heating members H2, the temperature sensors S are arranged. Hence, the temperatures in the vicinities of the respective image forming regions 11a for the four head units 21 are detectable.

Under the second heating members H2, a second heating unit 70 is arranged.

The second heating unit 70 includes a fourth heating member H4, such as a halogen heater, and is formed to have approximately the same shape as the support plate 32, for example.

The second heating unit 70, under the control of the controller 101, generates heat, and heats the intermediate transfer belt 11 together with the belt heating unit 40A when the temperature of the intermediate transfer belt 11 becomes lower than a predetermined value, for example. This increases the heat amount to be applied to the intermediate transfer belt 11, and accordingly can heat the intermediate transfer belt 11 to a predetermined temperature more quickly.

Control to heat the intermediate transfer belt 11 with the second heating unit 70 only is also available.

The shape of the second heating unit 70 is not limited to that mentioned above. However, if the second heating unit 70 has the aforementioned shape, it covers the belt supporting unit 30A and the belt heating unit 40A from underneath, so that a function of making the intermediate transfer belt 11 keep its temperature can be expected.

As described above, according to this embodiment, in the inkjet recording apparatus 1A, the belt supporting unit 30A includes the support plate 32 which supports the intermediate transfer belt 11 by the upper surface of the support plate 32 contacting the back of the image forming regions 11a of the intermediate transfer belt 11, and the second heating members H2 of the belt heating unit 40A are arranged so as to contact the lower surface of the support plate 32.

This keeps the ink flying distances more exactly the same, and accordingly can form higher-quality images, because the intermediate transfer belt 11 is supported by the support plate 32, and heated via the support plate 32.

Further, according to this embodiment, the inkjet recording apparatus 1A further includes the second heating unit 70 under the belt heating unit 40A.

This can control the temperature of the intermediate transfer belt 11 with higher efficiency.

Detailed configurations and detailed operations of the units and so forth constituting the image forming apparatus can be appropriately modified without departing from the scope of the present invention.

For example, in the first and second embodiments, the belt heating unit (a plurality of heating members) is arranged so as to correspond to the four head units 21, but not limited thereto. As long as the belt heating unit can heat the image forming regions 11a, the position thereof and the number of the heating members are not limited to those described in the above embodiments.

For example, as shown in FIG. 7, the second heating member(s) H2 may be installed at least at a position for heating the image forming region 11a for the head unit 21K which is arranged at the most downstream side. Because the head unit 21K is arranged at the furthest position from the first heating member H1, temperature control of the image forming region 11a for the head unit 21K is considered to be most important.

Further, as shown in FIG. 7, the second heating member(s) H2 may be installed on the upper side of the image forming region(s) 11a.

Further, although not shown, the second heating member(s) H2 may be installed, for example, between the head units 21M and 21C and/or between the head units 21C and 21K.

Further, in the first and second embodiments, the belt supporting unit 30 or 30A is provided, but it may not be provided.

Although some embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2018-014814 filed on Jan. 31, 2018 is incorporated herein by reference in its entirety.

What is claimed is:

1. An inkjet recording apparatus comprising:
a belt which is laid across at least two rollers so as to move around the rollers;
an image forming unit which ejects an ink to an image forming region of the belt, the image forming region being arranged between the rollers, thereby forming a primary image;
a transfer unit which transfers the primary image formed in the image forming region by the image forming unit to a recording medium;
a first heating unit which heats the image forming region; and
a hardware processor which controls a temperature of the image forming region by causing the first heating unit to heat the image forming region.

2. The inkjet recording apparatus according to claim 1, wherein
the image forming unit includes head units arranged side by side along a moving direction of the belt,
the first heating unit includes a heating member which heats at least the image forming region for, among the head units, a head unit arranged at a most downstream side, and
the hardware processor controls a heat amount of the heating member.

3. The inkjet recording apparatus according to claim 1, wherein
the image forming unit includes head units arranged side by side along a moving direction of the belt,
the first heating unit includes heating members which heat image forming regions included in the image forming region for the respective head units, and
the hardware processor controls heat amounts of the heating members individually.

4. The inkjet recording apparatus according to claim 2, further comprising a detector which detects the temperature of the image forming region, wherein
the hardware processor controls the heat amount of the heating member based on a result of the detection by the detector.

5. The inkjet recording apparatus according to claim 1, further comprising a supporting unit which supports the belt by contacting a back of the image forming region of the belt, wherein
the supporting unit is provided with the first heating unit.

6. The inkjet recording apparatus according to claim 5, wherein
the supporting unit includes a roller which supports the belt by an upper part of the roller contacting the back of the image forming region of the belt, and
the first heating unit is built in the roller.

7. The inkjet recording apparatus according to claim 5, wherein
the supporting unit includes a plate which supports the belt by an upper surface of the plate contacting the back of the image forming region of the belt, and
the first heating unit is arranged so as to contact a lower surface of the plate.

8. The inkjet recording apparatus according to claim 6, further comprising a second heating unit under the first heating unit.

9. The inkjet recording apparatus according to claim 7, further comprising a second heating unit under the first heating unit.

10. The inkjet recording apparatus according to claim 1, wherein the hardware processor sets a temperature for the image forming region according to a type or a basis weight of the recording medium.

11. The inkjet recording apparatus according to claim 1, wherein the hardware processor sets a temperature for the image forming region according to a quality or a density of an image to be formed on the recording medium.

12. The inkjet recording apparatus according to claim 1, further comprising a preheating unit which is arranged on an upstream side of the first heating unit in the moving direction of the belt, and heats the belt before the image forming unit forms the primary image to a preset initial temperature.
